(19) United States
(12) Patent Application Publication
(10) Pub. No.: US 2026/0129265 A1
(43) Pub. Date: May 7, 2026

(54) SYSTEMS AND METHODS FOR MODIFYING A CONTENT FEED PACE USING ARTIFICIAL INTELLIGENCE

(71) Applicant: Google LLC, Mountain View, CA (US)

(72) Inventors: Hao Li, Mountain View, CA (US); Zhen Zhang, Waterloo (CA); Zerong Yao, Mountain View, CA (US); Mengyu Fu, Santa Clara, CA (US); Liang Liu, Mountain View, CA (US); Kai Chen, Brisbane, CA (US); David McPeek, Redwood City, CA (US); Lina Lin, San Francisco, CA (US); Qixing Liang, San Mateo, CA (US); Zhen Chen, San Mateo, CA (US); Omkar Pathak, Santa Clara, CA (US); Sourabh Bansod, Mountain View, CA (US)

(21) Appl. No.: 19/378,315

(22) Filed: Nov. 3, 2025

Related U.S. Application Data
(60) Provisional application No. 63/716,005, filed on Nov. 4, 2024.

(51) Int. Cl. H04N 21/482; H04N 21/25; H04N 21/431

(52) U.S. Cl. CPC H04N 21/4826; H04N 21/251; H04N 21/431

(57) ABSTRACT

A method includes identifying, by a processing device of a content sharing platform, a request to load a content feed for a user of the content sharing platform. Based on the one or more features and using an artificial intelligence (AI) model, a content feed pace for the user is identified. A set of media items is selected based on the content feed pace. The set of media items is provided, via the content feed, for user consumption.

### RELATED APPLICATION

This application claims the benefit of U.S. Provisional Application No. 63/716,005, filed Nov. 4, 2024, the entire content of which is hereby incorporated by reference

### TECHNICAL FIELD

The disclosed implementations relate to methods and systems for modifying a content feed pace using artificial intelligence.

### BACKGROUND

Content sharing platforms allow users to connect to and share information with each other. Many content sharing platforms include a content sharing aspect that allows users to upload, view, and share content, such as video items, image items, audio items, and so on. Other users of the content sharing platform can comment on the shared content, discover new content, locate updates, share content, and otherwise interact with the provided content. The shared content can include content from professional channel owners, e.g., movie clips, TV clips, and music video items, as well as content from amateur channel owners, e.g., video blogging and short original video items.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

An aspect of the disclosure provides a computer-implemented method which includes identifying, by a processing device of a content sharing platform, a request to load a content feed for a user of the content sharing platform. Based on the one or more features and using an artificial intelligence (AI) model, a content feed pace for the user is identified. A set of media items is selected based on the content feed pace. The set of media items is provided, via the content feed, for user consumption.

A further aspect of the disclosure provides a system comprising: a memory; and a processing device, coupled to the memory, the processing device to perform a method according to any aspect or implementation described herein.

A further aspect of the disclosure provides a non-transitory computer-readable medium comprising instructions that, responsive to execution by a processing device, cause the processing device to perform operations according to any aspect or implementation described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of system architecture, in accordance with implementations of the disclosure.

FIGS. 2A-2B are illustrations of example graphical user interfaces (GUIs) showing a content feed recommendation on different user interfaces, in accordance with implementations of the disclosure.

FIG. 3 depicts a flow diagram of an example method for training an artificial intelligence model to predict a user's preferred feed pace, in accordance with implementations of the present disclosure, in accordance with implementations of the disclosure.

FIG. 4 is a flow diagram of an example method for generating a feed pace recommendation using an AI model, in accordance with implementations of the disclosure.

FIG. 5 depicts a block diagram of an example computing device operating in accordance with one or more aspects of the present disclosure.

### DETAILED DESCRIPTION

The content served by content sharing platforms can include video content, image content, audio content, text content, and so on (which may be collectively referred to as “media items”). Such media items can include audio clips, movie clips, TV clips, and music videos, as well as amateur content such as video blogging, short original videos, pictures, photos, other multimedia content, etc. The content can be presented in a stream, referred to a “content feed,” that users can scroll through. Typically, the content feed displays recommended media items in similar looking blocks that repeat one after another (e.g., appearing in a listing layout or a grid layout). Once a user stops scrolling, the displayed media item can autoplay for the user.

In some systems, the content feed can include a collection of video items that are tailored to a user's interests. In particular, when a user loads a user interface (UI) for the content feed, a selection of recommended video items can be generated to populate the content feed. The selection can be sourced using one or more algorithms that determine which video items are shown to the user. The algorithms can use, for example, the user's browsing history (e.g., by comparing the user's viewing habits to those of similar users), video relevance data (e.g., video items that are topically related to previously viewed video items), content interaction data (e.g., how the user interacted with certain video items, such as, for example, liking the video, ending the viewing session prematurely, etc.), and other such criteria for generating the recommendations. Potential video items for display are then scored and ranked before being selected for display in the content feed. For example, if a user's browsing history indicates a preference for video clips from a certain television show, then the content sharing platform may populate the content feed with recommended video clips from similar or related television shows.

When populating content feeds, current content sharing platforms typically only determine what type of content to provide to the user. However, these systems fail to consider parameters related to the duration or pacing of the provided content. In particular, depending on a user's current circumstances, the user may prefer to consume relatively short video items (e.g., 10 second videos, 30 second videos, etc.) rather than longer video items (e.g., videos with a duration of sixty seconds or more) or vice versa. For example, a user in a queue for a cup of coffee may desire a set of fast paced videos (e.g., a set of ten six-second videos) to pass the time. Alternatively, a user at home on their couch may desire relatively longer videos. As such, a feed that can match the pacing of presented content to the user's context could increase user engagement and platform efficiency. However, existing systems do not adapt pacing based on technical context parameters of a client device or its operating environment. Consequently, longer or high-bitrate videos may be selected even when network or device conditions are suboptimal, resulting in higher latency, excessive data transmission, and inefficient resource utilization during feed generation and delivery.

Aspects and implementations of the present disclosure address the above and other deficiencies by providing a system for modifying a content feed pace using an artificial intelligence (AI) model. A content feed pace can refer to the duration of media items (e.g., video items) provided for consumption in a user's content feed. In some implementations, when a user opens an application's content feed user interface (UI) or refreshes the content feed UI, the system of the present disclosure can use an AI model to predict a content feed pace appropriate for the user, and/or the user device's technical context parameters or operating environment. In some implementations, the system can provide, as input to the AI model, features related to the user or the client device, such as, for example, the location or type of location of the client device (e.g., at home, at a store, at an event, etc.), the current time of day, the type of client device (e.g., smartphone, laptop, etc.) that the user is currently using, and so forth. The AI model can then output predictive data reflecting how the user would interact with different content (e.g., videos) of various lengths. These predicted user interactions relate to, for example, predicting whether the user will skip to certain portions of certain videos, end viewing certain videos prior to their completion (e.g., for how long the user will watch the video), whether the user will “like” certain videos, “dislike” certain videos, comment on certain videos, etc. Using the output data, which reflects predictions of positive or negative user engagements with media items of different lengths, the system of the present disclosure can determine what type of content feed pace the user would prefer (e.g., a face pace showing relatively short videos, a mixed pace showing a mix of relatively short and long videos, a slow pace showing relatively long videos, etc.). For example, the system can determine, using the output data, whether the positive engagements pertaining to relatively short video items satisfies a threshold criterion (e.g., threshold value). If satisfied, the system can then select, for the user's content feed, media items of a certain duration.

Aspects of the present disclosure result in improved performance of content sharing platforms. In particular, the aspects of the present disclosure enable providing a content feed displaying media items having a pacing (e.g., video items of a certain duration) that can satisfy user preferences as well as technical context parameters associated with a client device and its operating environment, such as device type, network bandwidth, latency, location, or time of access. By using such parameters when generating a content feed, the platform can select media items having playback characteristics (e.g., duration, encoding, or buffering profile) appropriate to the current technical context. This results in improved performance of the content sharing platforms and more efficient operation of the underlying computing and communication infrastructure, including reduced data transmission, lower processing load, and decreased latency during feed generation and delivery.

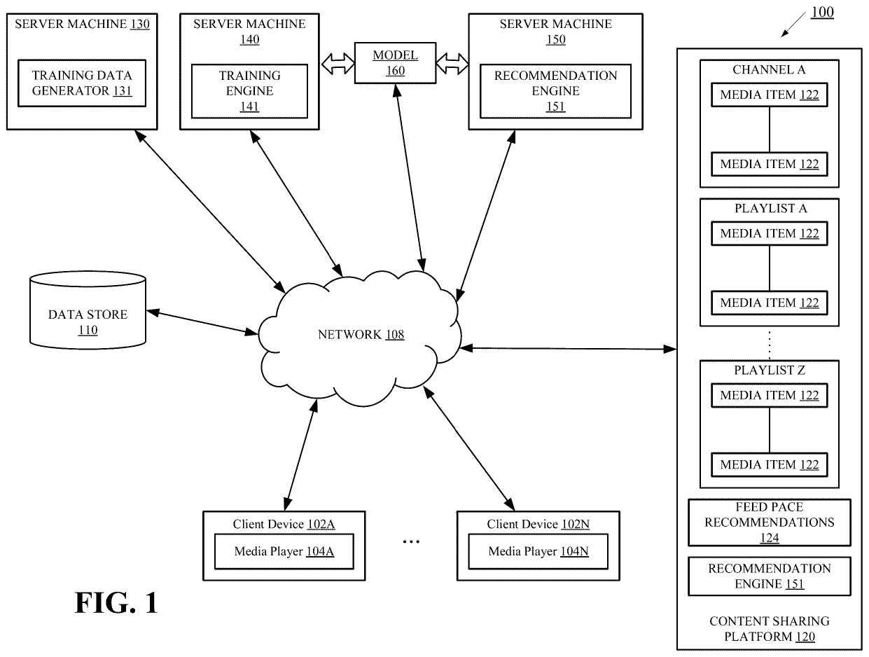

FIG. 1 illustrates an example system architecture 100, in accordance with implementations of the present disclosure. The system architecture 100 (also referred to as “system” herein) includes client devices 102A-102N, data store 110, content sharing platform 120, and/or server machines 130, 140, 150 each connected to a network 108. In some implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. Data store 110 can be hosted by one or more storage devices, such as main memory, magnetic or optical storage-based disks, tapes or hard drives, NAS, SAN, and so forth. In some implementations, data store 110 can be a network-attached file server, while in other implementations data store 110 can be some other type of persistent storage such as an object-oriented database, a relational database, and so forth, that may be hosted by application server 120 or one or more different machines (e.g., server machines 130, 140, 150, client device 102A-102N) coupled to the platform 120 via network 108.

Client devices 102A-102N can each include computing devices such as personal computers (PCs), laptops, mobile phones, smart phones, tablet computers, netbook computers, network-connected televisions, etc. In some implementations, client devices 102A-102N can also be referred to as “user devices.” In some implementations, each client device 102A-102N can include a media player 104A-104N. In some implementations, media player 104A-104N can be applications that allow users, such as channel owners, viewers, etc. to play back, view, or upload content, such as images, video items, web pages, documents, audio items, etc. For example, media players 104A-104N can be a web browser that can access, retrieve, present, or navigate content (e.g., web pages such as Hyper Text Markup Language (HTML) pages, digital media items, etc.) served by a web server.

Media player 104A-104N can render, display, or present the content (e.g., a web page, a media viewer) to a user. In some implementations, media player 104A-104N can provide a user interface for presenting the media items and/or enabling user interaction with the media player 104A-104N. Media player 104A-104N can also include an embedded media player (e.g., a Flash® player or an HTML5 player) that is embedded in a web page (e.g., a web page that can provide information about a product sold by an online merchant). In another example, media players 104A-104N can be a standalone application (e.g., a mobile application, or native application) that allows users to playback digital media items (e.g., digital video items, digital images, electronic books, etc.). According to aspects of the present disclosure, media players 104A-104N can be a content sharing platform application for users to record, edit, and/or upload content for sharing on the content sharing platform. As such, media players 104A-104N can be provided to client devices 102A-102N by content sharing platform 120. For example, media players 104A-104N can be embedded media players that are embedded in web pages provided by the content sharing platform 120. In another example, media players 104A-104N can be applications that are downloaded from content sharing platform 120.

In some implementations, media players 104A-104N can present, via respective user interfaces, a content feed of media items 122. The content feed can refer to a stream of regularly updated recommended media items (referred to as a batch), which can be organized in a chronological or prioritized sequence, for consumption by a user. The media items can be presented in similar looking blocks that repeat one after another. In particular, the content items can be presented in listing layout, a grid layout, etc. A user can scroll through the content feed to view different media items. In some implementations, once the user stops on a particular media item, that content item can automatically initiate playback (e.g., autoplay). For example, if the user stops scrolling on a particular video item, the video item can play for the user. In other implementations, the user may initiate playback via user input, such as, for example, hovering a cursor over the media item, selecting (e.g., clicking on) the media item, etc. In some instances, when the content feed is reloaded, a new batch of recommended content items can be displayed for consumption. As will be explained below in greater detail, the pacing of each batch of recommended content items can be determined using, for example, recommendation engine 151.

In some implementations, content sharing platform 120 and server machines 130, 140, 150, can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that can be used to provide a user with access to media items or provide the media items to the user. Content sharing platform 120 can allow a user to consume, upload, search for, approve of (“like”), disapprove of (“dislike”), or comment on media items. Content sharing platform 120 can also include a website (e.g., a webpage) or application back-end software that can be used to provide a user with access to the media items.

In some implementations of the disclosure, a “user” can be represented as a single individual. However, other implementations of the disclosure encompass a “user” being an entity controlled by a set of users and/or an automated source. For example, a set of individual users federated as a community in a social network can be considered a “user”. In another example, an automated consumer can be an automated ingestion pipeline, such as a topic channel, of the content sharing platform 120. In some implementations, the user can access content on sharing platform 120 through a user account. The user can access (e.g., log in to) the user account by providing user account information (e.g., username and password) via an application on client device 110 (e.g., media player 104A-104N). In some implementations, the user account can be associated with a single user. In other implementations, the user account can be a shared account (e.g., family account shared by multiple users) (also referred to as “shared user account” herein). The shared account can have multiple user profiles, each associated with a different user. The multiple users can login to the shared account using the same account information or different account information. In some implementations, the multiple users of the shared account can be differentiated based on the different user profiles of the shared account.

In some implementations, an authorizing data service (also referred to as a “core data service” or “authorizing data source” herein) is a secure service that has access to data pertaining to user accounts on the content sharing platform 120 and that can use this data to decide whether to authorize a user account to obtain a requested content. In some implementations, the authorizing data service can authorize a user account (e.g., a client device associated with the user account) to access the requested content, authorize delivery of the requested content to the client device, or both. Authorization of the delivery of the content can involve authorizing how the content is delivered. In some implementations, the authorizing data service can use user account information to authorize the user account. In some implementations, an authentication token associated with client device 102A-102N or media player 104A-104N can be used to determine whether to authorize the user account and/or playback of requested content. In some implementations, the authorizing data service is part of content sharing platform 120. In other implementations, the authorizing data service can be an external service, such as a highly-secured authorizing service offered by a third-party.

In some implementations, content delivery platform 120 can use a content distribution network (CDN) (not shown) to stream the media items to one or more client devices 102A-102N for consumption by users. A CDN includes a geographically distributed network of servers that work together to provide fast delivery of content. The network of the servers can be geographically distributed to provide high availability and high performance by distributing content or services based, in some instances, on proximity to client devices 102A-102Z. The closer a CDN server is to a client device 102A-102N, the faster the content can be delivered to the client device 102A-102N.

A media item can include an electronic file that can be executed or loaded using software, firmware or hardware configured to present the media item to a user. A media item 122 can include, and is not limited to, digital video, digital movies, digital photos, digital music, audio content, melodies, website content, social media updates, electronic books (ebooks), electronic magazines, digital newspapers, digital audio books, electronic journals, web blogs, real simple syndication (RSS) feeds, electronic comic books, software applications, etc. In some implementations, the media item 122 can be a live-stream media item. In some implementations, content sharing platform 120 can store the media items 122 using the data store 106, or can the media items (or an identifier of the media item) as electronic files in one or more formats using data store 106.

A video item is used as an example of a media item 122 throughout this disclosure. A video item is a set of sequential image frames representing a scene in motion. For example, a series of sequential image frames can be captured continuously or later reconstructed to produce animation. Video items can be presented in various formats including, but not limited to, analog, digital, two-dimensional and three-dimensional video. Further, video items can include movies, video clips or any set of animated images to be displayed in sequence. In addition, a video item (or media item) can be stored as a video file that includes a video component and an audio component. The video component can refer to video data in a video coding format or image coding format (e.g., H.264 (MPEG-4 AVC), H.264 MPEG-4 Part 2, Graphic Interchange Format (GIF), WebP, etc.). The audio component can refer to audio data in an audio coding format (e.g., advanced audio coding (AAC), MP3, etc.). It can be noted GIF can be saved as an image file (e.g., .gif file) or saved as a series of images into an animated GIF (e.g., GIF89a format). It can be noted that H.264 can be a video coding format that is a block-oriented motion-compensation-based video compression standard for recording, compression, or distribution of video content, for example.

In some implementations, the media item can be streamed, such as in a live-stream, to one or more of client devices 102A-102Z. It is be noted that “streamed” or “streaming” refers to a transmission or broadcast of content, such as a media item, where the received portions of the media item can be played back by a receiving device immediately upon receipt (within technological limitations) or while other portions of the media content are being delivered, and without the entire media item having been received by the receiving device. “Stream” can refer to content, such as a media item, that is streamed or streaming. A live-stream media item can refer to a live broadcast or transmission of a live event, where the media item is concurrently transmitted, at least in part, as the event occurs to a receiving device, and where the media item is not available in its entirety.

In some implementations, content sharing platform 120 can allow users to create, share, view or use playlists containing media items (e.g., playlist A-Z, containing media items 122). A playlist refers to a collection of media items that are configured to play one after another in a particular order without any user interaction. In some implementations, content sharing platform 120 can maintain the playlist on behalf of a user. In some implementations, the playlist feature of the content sharing platform 120 allows users to group their favorite media items together in a single location for playback. In some implementations, content sharing platform 120 can send a media item on a playlist to client device 102A-102N for playback or display. For example, media player 104A-104N can be used to play the media items on a playlist in the order in which the media items are listed on the playlist. In another example, a user can transition between media items on a playlist. In yet another example, a user can wait for the next media item on the playlist to play or can select a particular media item in the playlist for playback.

The content sharing platform 120 can include multiple channels (e.g., channels A through Z, of which only channel A is shown in FIG. 1) for providing media items from a common source or having a common topic, theme, or substance. Each channel can include one or more media items and can be managed by an owner (referred to as a “channel owner”), who is a user that can perform administrative actions on the channel. The administrative actions can include making media items available on the channel (e.g., choosing, uploading, and/or allowing presentation of the media items), enabling advertisements for the media items, enabling one or more membership tiers on the channel, etc. For example, a channel X (not shown) can include video media items Y and Z that were uploaded by the channel owner.

In some implementations, the channel owner can enable channel memberships that provide one or more membership tiers on a channel. Each membership tier can allow “members” to join the channel through monthly fees and receive privileges (e.g., members-only benefits) that can include access to exclusive content, badges, emojis, access to live-streams, chats, etc. In some implementations, a particular channel can offer multiple membership tiers, where each level can include different privileges for a different monthly fee.

In some implementations, content sharing platform 120 (and/or server machine 150) can include recommendation engine 151 that can generate feed pace recommendations 124 to the users of content sharing platform 120. A feed pace recommendation 124 can include an indication of a user's current preferred media item pace for consuming a set of media items 122 displayed in their content feed. As discussed above, media items 122 in a content feed can be presented in similar looking blocks that repeat one after another and through which the user can scroll.

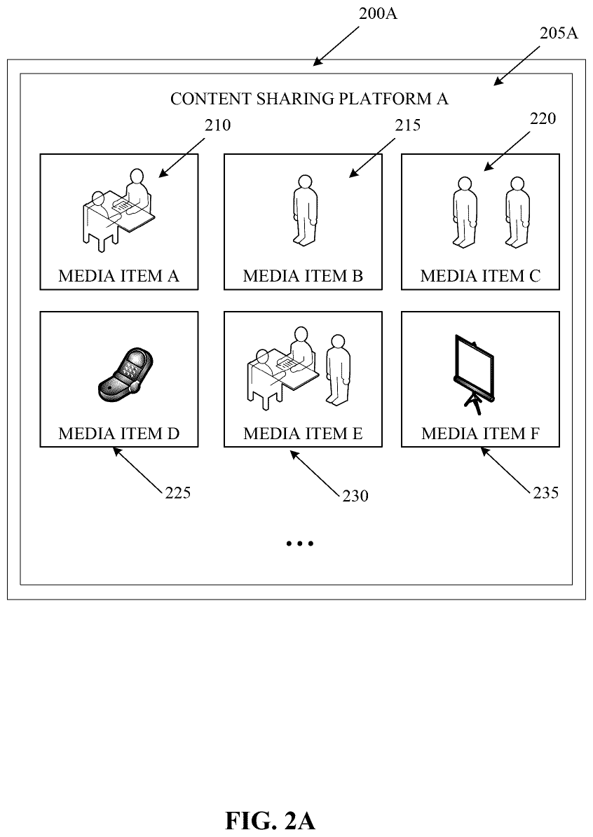

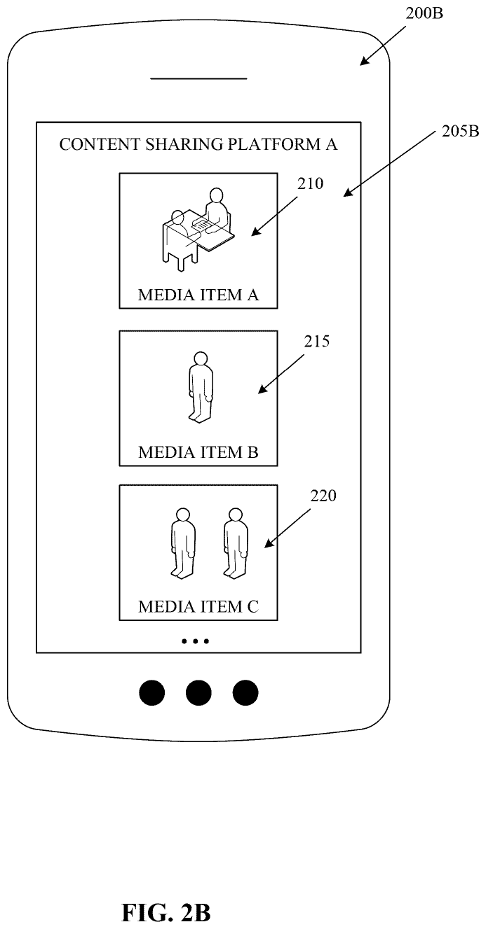

FIGS. 2A-2B are example graphical user interface (GUI) showing a content feed recommendation on the UI of different client devices, in accordance with implementations of the present disclosure. In particular, FIG. 2A shows GUI 205A on a display device of a client device 200A while FIG. 2B shows GUI 205B on a display device of a client device 200B. By way of an illustrative example, client device 200A can be a computer screen and client device 200B can be a smartphone screen. FIG. 2A shows media items 210, 215, 220, 225, 230, and 235 displayed in a content feed using a grid layout. FIG. 2B shows media items 210, 215, and 220 displayed in a content feed using a listing layout. In both instances, a user can scroll through the content feed to display additional content items.

Returning to FIG. 1, in some implementations, a feed pace recommendation 124 can be made using data from a variety of sources including historical and/or current data related to the user, other users, channels, media items, membership plans, playlist media items, recently watched media items, media item ratings, information from a cookie(s), user history, regional data, viewer activity, fanship data (e.g., number of likes, number of subscribers, number of shares, etc.), media item duration data (e.g., the length of a media item), media item duration type data (e.g., whether the media item is a normal video or a “short” video), user interaction data (e.g., whether the user skips to certain portions of the video, ends viewing the video prior to the completion of the video, etc.), duration of watch data (e.g., how long the user consumed the media item), time of watched content (e.g., the time of day that the media item was consumed), the type of client device used when viewing certain content (e.g., smartphone, laptop, etc.), location data (e.g., geographic region of the user, specific location of the user, type of location of the user such as, for example, whether the user is at home, away from home, in a store, at an event, etc.), and other sources. In some implementations, a feed pace recommendation 124 can be based on output of a trained AI model 160. In some implementations, the feed pace recommendation 124 can be used to select or aid in the selection of a set of media items to be presented on media player 104A-104N (e.g., on the user interface associated with a content feed).

AI model 160 can be a machine learning model trained to generate output related to feed pace recommendations 124 and/or trained to generate feed pace recommendations. In particular, AI model 160 can be trained (e.g., using training data sets having labeled historic data) to predict a preferred feed pace for a recommendation request and/or predict whether a user will have positive or negative user engagements with certain media items of different lengths. It is noted that one user can have multiple recommendation requests across a time period (when they open up the application or refresh the application), and AI model 160 can provide different pace recommendations for the same user. In some implementations, AI model 160 can be trained to learn relationships between certain user-related data associated with sets of previously recommended videos items (for a content feed) and related user engagement data (or between individual video items and related user engagement data). Each set can include related labels or metadata reflecting the user-related data, such as, for example, the context related to the batch (e.g., location of the user when the batch was provided, local time the batch was provided, the device type on which the batch was provided, etc.). The user engagement data can include, for example, user interaction data, fanship data (e.g., likes, dislikes, etc.), duration of watch data (e.g., how long the user consumed the content), user interaction data (e.g., whether the user skips to certain portions of the video, ends viewing the video prior to the completion of the video, etc.), and so forth.

In some implementations, in order to generate feed pace recommendation 124 (e.g., inference phase), recommendation engine 151 can use, as input for one or more trained AI models (e.g., AI model 160), the user-related data reflecting the current user location, the time of the day, data reflecting how the user previously reacted with similar settings, the type of device the user is using, etc. Recommendation engine 151 can then obtain, as output from the trained AI model, a preferred feed pace for the user and/or predict whether the user will have positive or negative user engagements with certain media items of different lengths. For example, the preferred feed pace can indicate whether the user currently prefers a fast-paced feed (e.g., to consume relatively short videos), a mixed feed (e.g., to consume videos of different durations), a slow-paced feed (e.g., to consume video of an average length or relatively longer videos), etc. Recommendation engine 151 can then determine, based on the output data, a set of videos to display in the user's content feed. For example, recommendation engine 151 can use the feed pace recommendation in addition to one or more content feed recommendation systems to generate media items for a content feed. The content feed recommendation system(s) can be any recommendation system that uses, for example, algorithms, heuristic models, AI models, or any other model to generate the feed pace recommendations. In other implementations, the content feed recommendation system can be part of recommendation engine 151.

Training data generator 131 (residing at server machine 130) can generate training data to be used to train AI model 160. In some implementations, training data generator 131 can generate the training data using user-related data associated with media items (e.g., previously recommended videos items for a content feed) and related user engagement data (e.g., user interaction data, fanship data, duration of watch data, user interaction data, etc.). In some implementations, certain elements of the training data can be labeled with video or user related data, such as, for example, the location of the user when the batch was provided, local time the batch was provided, etc.

Server machine 140 may include a training engine 141. Training engine 141 can train the AI model 160 using the training data from training data generator 131. In some implementations, the AI model 160 can be created by the training engine 141 using the training data that includes training inputs (e.g., video item data, user engagement data, etc.) and corresponding target outputs (correct answers for respective training inputs, such as the recommended feed pace). The training engine 141 can find patterns in the training data that map the training input to the target output (the answer to be predicted) and provide AI model 160 that captures these patterns. The AI model 160 can perform, for example, a single level of linear or non-linear operations. An example of a deep network is a neural network with one or more hidden layers, and such an AI model can be trained by, for example, adjusting weights of a neural network in accordance with a backpropagation learning algorithm or the like. In other or similar implementations, the AI model 160 can refer to the model artifact that is created by training engine 141 using training data that includes training inputs. Training engine 141 can find patterns in the training data, identify clusters of data that correspond to the identified patterns, and provide the AI model 160 that captures these patterns. AI models 160 can use one or more of support vector machine (SVM), Radial Basis Function (RBF), clustering, supervised machine learning, semi-supervised machine learning, unsupervised machine learning, k-nearest neighbor algorithm (k-NN), linear regression, multi-linear regression, non-linear regression, random forest, gradient-boosted trees, neural network (e.g., artificial neural network), etc.

In some implementations, AI model 160 can include a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), or a large language model (LLM). In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

Server machine 150 can include recommendation engine 151, which can be configured to utilize AI model 160 to generate prediction data for a recommendation request. In particular, recommendation engine 151 can provide, as input to AI model 160, data reflecting current user location data, the time of the day, data reflecting how the user previously reacted with similar settings, etc. Recommendation engine 151 can then obtain one or more outputs from AI model 160, the one or more outputs reflecting one or more feed pace recommendations 124, or used to generate one or more feed pace recommendations 124. In particular, AI model 160 can provide one or more outputs that include data indicative of the recommended feed pace for a user. In some implementations, recommendation engine 151 can store the predicted output data (e.g., incentives recommendation 124) on data store 110.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

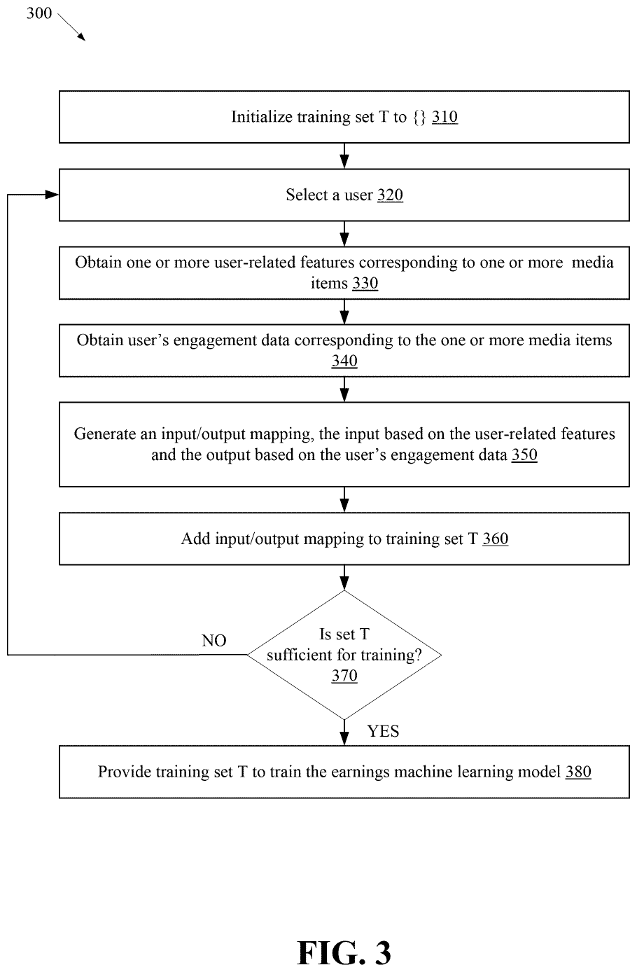

FIG. 3 depicts a flow diagram of an example method 300 for training an AI model to predict a user's preferred feed pace, in accordance with implementations of the present disclosure. Method 300 can be performed by processing logic that can include hardware (circuitry, dedicated logic, etc.), software (e.g., instructions run on a processing device), or a combination thereof. In one implementation, some or all of the operations of method 300 can be performed by one or more components of system 100 of FIG. 1. In some implementations, some or all of the operations of method 300 can be performed by training data generator 131 and/or training engine 141, as described above.

For simplicity of explanation, method 300, as well as any other method of this disclosure, is depicted and described as a series of acts. However, acts in accordance with this disclosure can occur in various orders and/or concurrently, and with other acts not presented and described herein. Furthermore, not all illustrated acts may be required to implement method 300 in accordance with the disclosed subject matter. In addition, those skilled in the art will understand and appreciate that method 300 could alternatively be represented as a series of interrelated states via a state diagram or events. Additionally, it should be appreciated that method 300 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At operation 310, processing logic initiates training set T to { } (e.g., to empty).

At operation 320, processing logic selects a user (or a user's recommendation request). The user can be a viewer that has previously consumed videos on content sharing platform 120.

At operation 330, processing logic obtains one or more user-related features corresponding to one or more media items. The media items can be media items that the user has previously viewed, interacted with, were provided for consumption in a content feed for the user, etc. The user-related features (e.g., labels, metadata, etc.) can include, for example, the location of the user when the media item(s) were provided and/or consumed, local time the media items were provided for user consumption, the type of client device on which the media item(s) were provided, etc. In some implementations, operation 330 can obtain a batch of media items that were populated in the user's content feed and then obtain the corresponding user-related features.

At operation 340, processing logic obtains the user's engagement data corresponding to the one or more media items. The user engagement data can include, for example, user interaction data (e.g., whether the user skips to certain portions of the video, ends viewing the video prior to the completion of the video, etc.), duration of watch data (e.g., how long the user consumed each media item), fanship data (e.g., whether the user liked the media item, disliked the media item, commented on the media item, aggregated statistics related regarding user engagement data for multiple media items, etc.

At operation 350, processing logic generates an input/output mapping, the input based on the user-related features and the output based on the user engagement data.

At operation 360, processing logic adds the input/output mapping to training set T.

At operation 370, processing logic determines whether set T is sufficient for training. In response to processing logic determining that set T is not sufficient for training, method 300 can return to operation 320. The processing logic can then select another user, select different or additional media items, user-related features, and/or engagement data for a previously selected user, etc. In response to processing logic determining that set T is sufficient for training, method 300 can proceed to operation 380.

At operation 380, processing logic provides training set T to train an AI model, such as AI model 160, as described above.

Once the processing logic provides the training set T to train the AI model, the AI model can be trained to generate, for a given user, predictive data related to the feed pace recommendation. In an example, the AI model can receive, as input, user-related features (e.g., the user location, the time of data, device type, etc.) and provide, as output, a probability that the user will like content of a certain duration, predictions of positive or negative user engagements with media items of different lengths, determine what type of content feed pace the user would prefer (e.g., whether the user will prefer a fast-paced feed, a mixed pace feed, etc.), and so forth.

In some implementations, the processing logic can retrain or update the AI model periodically. For example, the processing logic can obtain new user-engagement data and/or new user-related features and update the weights of the AI model. This can be done daily, weekly, during any other interval, in response to an operator request (e.g., an administrator), etc. In some implementations, the processing logic can generate a global AI model using data from multiple users, then fine-tune the AI model to a specific user using that user's data (e.g., user-engagement data and/or new user-related features). Similarly, the personalized AI model(s) can be periodically updated using data from multiple users or from the user to whom the AI model is personalized.

In some implementations, the AI model can be trained to generate recommendations related to content feed having a particular focus. For example, the AI model can be trained to determine whether the user would prefer a creation focus feed (content that inspires causal users to create), a music focused feed (content focusing on music videos), a consumption focused feed (e.g., content from movies and TV shows), etc. To train such AI models, additional labels can be used to identify content from creators, content related to music, content for consumption, etc.

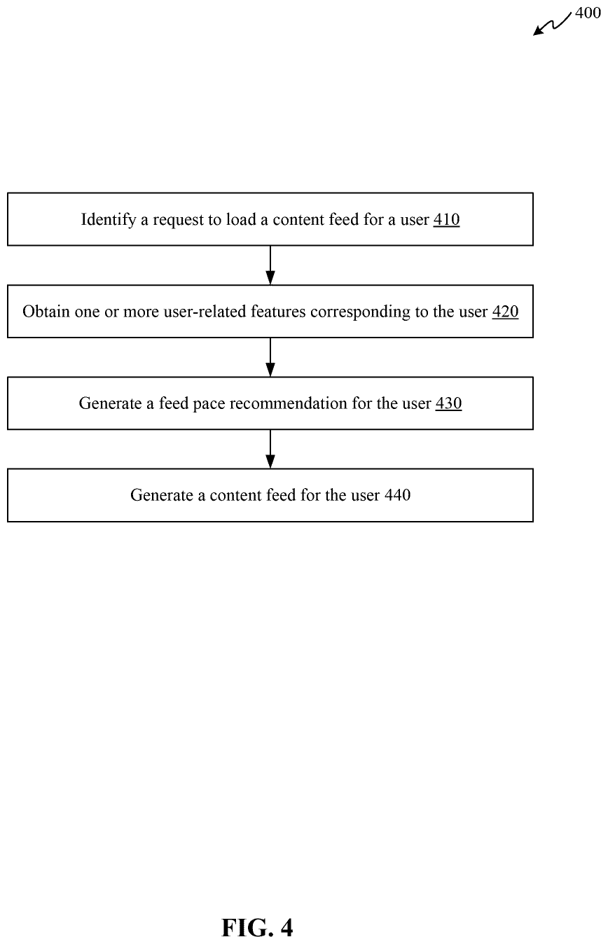

FIG. 4 depicts a flow diagram of an example method 400 for generating a feed pace recommendation using an AI model, in accordance with implementations of the present disclosure. Method 400 can be performed by processing logic that can include hardware (circuitry, dedicated logic, etc.), software (e.g., instructions run on a processing device), or a combination thereof. In one implementation, some or all of the operations of method 400 can be performed by one or more components of system 100 of FIG. 1. In some embodiments, some or all of the operations of method 400 can be performed by recommendation engine 151, as described above.

At operation 410, processing logic identifies a request to load a content feed for a user. The request can be initiated by, for example, a user opening an application of a content sharing platform, selecting a refresh function on an already displayed content feed, etc.

At operation 420, processing logic obtains one or more user-related features corresponding to the user. The user-related features can include, for example, the current location of the user, the current local time, the type of client device on which the request was made, etc.

At operation 430, processing logic generates a feed pace recommendation for the user. In particular, the processing logic provides an indication of the one or more user-related features as input to an AI model. The AI model can be AI model 160. The AI model 160 can be trained via, for example, method 300 of FIG. 3. The processing logic then, via the trained AI model, obtains an output from the AI model. The output can be indicative of, for example, a feed pace prediction for the user. In particular, the output can provide a probability that the user will like content of a certain duration, predictions of positive or negative user engagements with media items of different lengths, determine what type of content feed pace the user would prefer (e.g., whether the user will prefer a fast-paced feed, a mixed pace feed, etc.), etc. The processing logic can then determine, using the output, a feed pace recommendation. In an illustrative example, the output can provide a value reflecting whether the user will have a positive or negative experience with relatively short content (e.g., content under thirty seconds long). In this illustrative example, the higher the value, the more positive the predicted experience while a lower value (or a negative value) can be indicative of a negative experience with relatively short content. In response to determining that the value satisfies a threshold criterion (e.g., a threshold value), the processing logic can determine that the user would prefer a fast-paced feed. In response to the value failing to satisfy the threshold criterion, the processing logic can determine that the user would prefer a mixed-paced feed (or other type of feed pace). It is noted that multiple threshold criterions can be used that distinguish between different types of feed paces (e.g., fast-paced feed, mixed-pace feed, slow-paced feed, etc.).

At operation 440, processing logic generates a content feed for the user. In particular, the processing logic can use the feed pace recommendation in selecting media items (e.g., video items) to populate the user's content feed. The media items can be selected using one or more algorithms, AI models, heuristic models, etc. In an example, the feed generating algorithm can select potential video items for display using, for example, the user's browsing history, video relevance data (e.g., video items that are topically related to previously viewed video items), content interaction data (e.g., how the user interacted with certain video items, such as, for example, liking the video), and other such criteria for generating the recommendations. The potential video items can then be filtered using the feed pace recommendation (e.g., remove videos that have a during outside the scope of the recommended feed pace), and then scored, ranked, and displayed in the content feed.

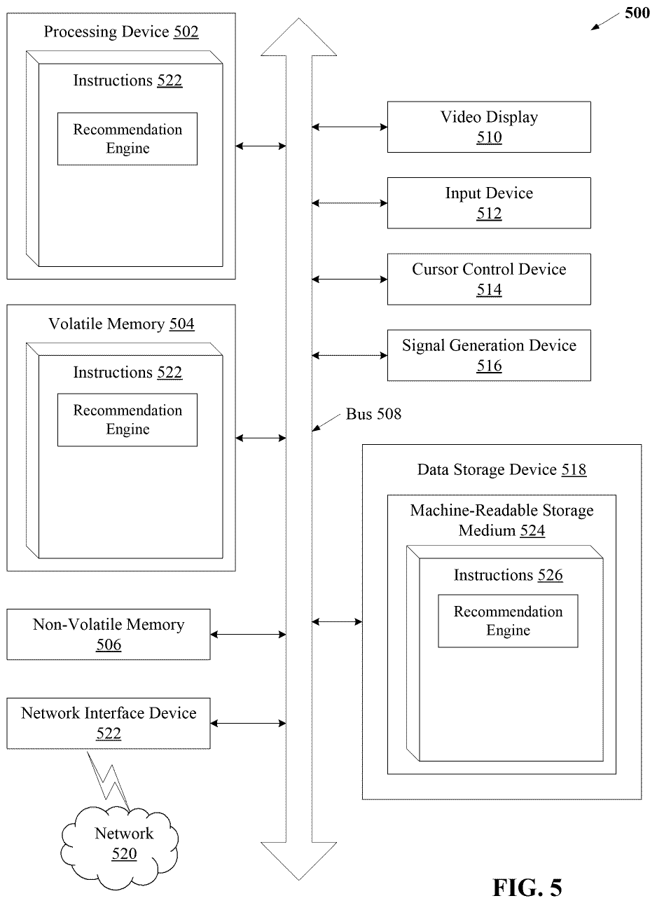

FIG. 5 depicts a block diagram of a computer system operating in accordance with one or more aspects of the present disclosure. In certain implementations, computer system 500 can be connected (e.g., via a network, such as a Local Area Network (LAN), an intranet, an extranet, or the Internet) to other computer systems. Computer system 500 can operate in the capacity of a client device. Computer system 500 can operate in the capacity of a server or a client computer in a client-server environment. Computer system 500 can be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 can include a processing device 502, a volatile memory 504 (e.g., random access memory (RAM)), a non-volatile memory 506 (e.g., read-only memory (ROM) or electrically erasable programmable ROM (EEPROM)), and a data storage device 518, which can communicate with each other via a bus 508.

Processing device 502 can be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 500 can further include a network interface device 522. Computer system 500 also can include a video display unit 510 (e.g., an LCD), an input device 512 (e.g., a keyboard, an alphanumeric keyboard, a motion sensing input device, touch screen), a cursor control device 514 (e.g., a mouse), and a signal generation device 516.

Data storage device 518 can include a non-transitory machine-readable storage medium 524 on which can store instructions 526 encoding any one or more of the methods or functions described herein, including instructions encoding components of client device of FIG. 1 for implementing methods 300 and 400.

Instructions 526 can also reside, completely or partially, within volatile memory 504 and/or within processing device 502 during execution thereof by computer system 500, hence, volatile memory 504 and processing device 502 can also constitute machine-readable storage media.

While machine-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “determining,” “sending,” “displaying,” “identifying,” “selecting,” “excluding,” “creating,” “adding,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can comprise a general-purpose computer system selectively programmed by a computer program stored in the computer system. Such a computer program can be stored in a computer-readable tangible storage medium.

The methods and illustrative examples described herein are not inherently related to any particular computer or other apparatus. Various general-purpose systems can be used in accordance with the teachings described herein, or it can prove convenient to construct more specialized apparatus to perform methods 300 and 400 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
identifying, by a processing device of a content sharing platform, a request to load a content feed for a user of the content sharing platform;
identifying, based on the one or more features and using an artificial intelligence (AI) model, a content feed pace for the user;
selecting a set of media items based on the content feed pace; and
providing, via the content feed, the set of media items for user consumption.

2. The method of claim 1, wherein an output of the AI model reflects whether the user is to have a positive or negative experience with content of a certain duration.

3. The method of claim 1, wherein each of the one or more features reflects at least one of: a type of current location of a client device of the user, a current local time, or a type of client device on which the request was initiated.

4. The method of claim 1, wherein the request comprises loading a user interface of an application associated with the content sharing platform or refreshing the user interface.

5. The method of claim 1, wherein the content feed pace reflects a desired duration of the media items in the content feed.

6. The method of claim 1, further comprising:
identifying a value from an output of the AI model; and
in response to determining that the value satisfies a threshold criterion, generating the content feed pace.

7. The method of claim 1, wherein the AI model is trained to provide as output at least one of a probability of a user preferring content of a certain duration, a prediction of user engagements with media items of different lengths, or a determination of a type of content feed pace preferred by the user.

8. A system comprising:
a memory; and
a processing device, coupled to the memory, the processing device to perform operations comprising:
identifying a request to load a content feed for a user of a content sharing platform;
identifying, based on the one or more features and using an artificial intelligence (AI) model, a content feed pace for the user;
selecting a set of media items based on the content feed pace; and
providing, via the content feed, the set of media items for user consumption.

9. The system of claim 8, wherein an output of the AI model reflects whether the user is to have a positive or negative experience with content of a certain duration.

10. The system of claim 8, wherein each of the one or more features reflects at least one of: a type of current location of a client device of the user, a current local time, or a type of client device on which the request was initiated.

11. The system of claim 8, wherein the request comprises loading a user interface of an application associated with the content sharing platform or refreshing the user interface.

12. The system of claim 8, wherein the content feed pace reflects a desired duration of the media items in the content feed.

13. The system of claim 8, wherein the operations further comprise:
identifying a value from an output of the AI model; and
in response to determining that the value satisfies a threshold criterion, generating the content feed pace.

14. The system of claim 8, wherein the AI model is trained to provide as output at least one of a probability of a user preferring content of a certain duration, a prediction of user engagements with media items of different lengths, or a determination of a type of content feed pace preferred by the user.

15. A non-transitory computer-readable medium comprising instructions that, responsive to execution by a processing device, cause the processing device to perform operations comprising:
identifying a request to load a content feed for a user of a content sharing platform;
identifying, based on the one or more features and using an artificial intelligence (AI) model, a content feed pace for the user;
selecting a set of media items based on the content feed pace; and
providing, via the content feed, the set of media items for user consumption.

16. The non-transitory computer readable storage medium of claim 15, wherein an output of the AI model reflects whether the user is to have a positive or negative experience with content of a certain duration.

17. The non-transitory computer readable storage medium of claim 15, wherein each of the one or more features reflects at least one of: a type of current location of a client device of the user, a current local time, or a type of client device on which the request was initiated.

18. The non-transitory computer readable storage medium of claim 15, wherein the request comprises loading a user interface of an application associated with the content sharing platform or refreshing the user interface.

19. The non-transitory computer readable storage medium of claim 15, wherein the content feed pace reflects a desired duration of the media items in the content feed.

20. The non-transitory computer readable storage medium of claim 15, wherein the operations further comprise:
identifying a value from an output of the AI model; and
in response to determining that the value satisfies a threshold criterion, generating the content feed pace.
